(19) United States
(12) Patent Application Publication
(10) Pub. No.: US 2024/0328558 A1
(43) Pub. Date: Oct. 3, 2024

(54) LIQUID CONNECTOR FOR HOSE TROLLEY

(71) Applicant: HUSQVARNA AB, Huskvarna (SE)

(72) Inventors: Axel Mock, Blaustein (DE); Tobias Schlegel, Illerkirchberg (DE)

(21) Appl. No.: 18/702,514

(22) PCT Filed: Sep. 5, 2022
(86) PCT No.: PCT/EP2022/074624

§ 371 Date: Apr. 18, 2024

(30) Foreign Application Priority Data
Oct. 19, 2021 (EP) 21203464.9

(51) Int. Cl. F16L 41/03; B65H 75/40; B65H 75/44; F16L 41/02

(52) U.S. Cl. CPC F16L 41/03; B65H 75/403; B65H 75/4471; F16L 41/023

(57) ABSTRACT

A liquid connector (160) for a hose trolley (100). The liquid connector (160) includes a body (162) defining an inlet (164) and a plurality of outlets (166, 166′). The body (162) allows flow of a liquid from the inlet (164) to one or more of the plurality of outlets (166, 166′). A fixing element (168) is adapted to allow coupling of the liquid connector (160) with the hose trolley (100). The inlet (164) of the body (162) has a coupling element (163) which allows coupling of a hose (165). The liquid connector (160) is characterized in that the fixing element (168) is one or more coupling elements (169) provided on the body (162). The one or more coupling elements (169) allow removable coupling of the liquid connector (160) with a corresponding structure.

### TECHNICAL FIELD

The present disclosure relates to a hose trolley. More specifically, the present disclosure relates to a liquid connector for the hose trolley having multiple applications.

### BACKGROUND

A hose trolley is generally used to carry a hose box to different installations, such as lawns, gardens, parks, and the like for providing a flow of liquid, such as water. The conventional hose trolley includes a frame that may further include a handle, some support features, one or more wheels and a hose box.

The conventional hose trolley however poses some limitations. The hose trolley does not include additional liquid units such as a watering tap or a sprinkler. Such additional liquid units may be required to perform tasks that may not be readily accomplished by the hose trolley. The watering tap may be required for example for cleaning purposes by users after performing gardening operations such as digging or seeding while the sprinkler may be required to sprinkle an area of a lawn with a fluid i.e., water. Such limitations will then compel the user to travel towards a water source, which may be away from the gardening area. Similarly, the user may need to exert (say bend down) to place a sprinkler on the lawn and then connect the sprinkler with a hose to the water tap. Thus, lack of the additional liquid units with the hose trolley thus demands extra efforts on the part of the user and compels the user to push themselves to unergonomic positions.

An example of a hose trolley is provided in U.S. Pat. No. 7,182,274 (hereinafter referred to as '274 reference). The '274 reference provides a sprinkler apparatus providing multiple operational modes. The apparatus may operate as a conventional traveling sprinkler. In addition, the apparatus may provide one or more additional ports so that a user may attach additional hoses or other watering or irrigation equipment. However, the '274 reference falls short of providing a removable coupling arrangement for the one or more liquid connectors (or additional ports) for coupling the additional liquid units with the sprinkler apparatus. The additional liquid units, due to their fixed nature, may pose limitations when not required for performing a certain application/operation. They may also occupy additional space during storage of the sprinkler apparatus.

Thus, there is a need of an improved hose trolley with a liquid connector providing multiple and customizable applications.

### SUMMARY

In view of the above, it is an objective of the present invention to solve or at least reduce the drawbacks discussed above. The objective is at least partially achieved by a liquid connector for a hose trolley. The liquid connector includes a body defining an inlet and a plurality of outlets. The body allows flow of a liquid from the inlet to one or more of the plurality of outlets. A fixing element is adapted to allow coupling of the liquid connector with the hose trolley. The inlet of the body includes a coupling element which allows coupling of a hose. The liquid connector is characterized in that the fixing element is one or more coupling elements provided on the body. The one or more coupling elements allow removable coupling of the liquid connector with a corresponding structure.

Thus, the present disclosure provides a liquid connector that may increase the overall utility of the hose trolley. The liquid connector may provide benefits of an additional liquid unit such as, but not limited to, a water tap. The water tap may be adapted for a wide range of applications such as hand cleaning, bucket filling etc. The liquid connector may further allow connection to a sprinkler. Thus, the sprinkler may be installed in a garden, lawn, or the like without the need of a separate (tripod) arrangement. Further, the liquid connector may promote better (say upright) ergonomic working posture for a user, by limiting a need to pick up accessories such as shower from the ground, installing sprinklers on the ground etc. Furthermore, the removable coupling of the liquid connector may allow for easy servicing and replacement of the liquid connector. The removable coupling may also give the user a freedom to couple the liquid connector with the hose trolley only when required and save space during storage. The removable coupling may also allow the coupling of the liquid connector at various positions and height on the hose trolley according to the user comfort, among other factors.

According to an embodiment of the present disclosure, the plurality of outlets are two outlets. Further, a flow of the liquid from the outlets is regulated by one or more of a regulating valve, and an aqua stop tap. The plurality of outlets of the liquid connector may increase the utility of the liquid connector and hence the hose trolley. Multiple number of the outlets may allow more and different additional liquid units or accessories such as sprinklers, showers, taps and the like, that may be connected to the liquid connector.

According to an embodiment of the present disclosure, the outlet with the regulating valve is provided with a knob to control flow of the liquid therethrough, and the outlet with the aqua stop tap is provided with a self-closing tap connector. The liquid flow from the plurality of outlets may be regulated or controlled using knobs or self-closing tap connectors. This may further improve efficiency and ease of use of the overall operations of the hose trolley.

According to an embodiment of the present disclosure, the corresponding structure is a tube or a handle of the hose trolley. The liquid connector may be removably coupled along different positions, angles, places, and the like with the handle of the hose trolley as per personal preference or application requirements.

According to an embodiment of the present disclosure, the one or more coupling elements allow coupling by one or more of a screw connection, fixtures, and clips. The removable coupling may be accomplished using accessories that are robust, light in weight and may be worked upon by any person even with limited requirement of any tools, technical knowledge, or skill.

According to an embodiment of the present disclosure, the hose trolley includes a frame defining a central axis. The frame includes a handle, and one or more wheels are adapted to transport the frame. Further, the hose trolley includes a hose box housed with the frame and a liquid connector for the hose trolley. The liquid connector includes a body defining an inlet and a plurality of outlets. The body allows flow of a liquid from the inlet to one or more of the plurality of outlets. A fixing element is adapted to allow coupling of the liquid connector with the hose trolley. The hose trolley is characterized in that the fixing element is one or more coupling elements provided on the body. The one or more coupling elements allow removable coupling of the liquid connector with a corresponding structure of the hose trolley. The inlet of the body includes a coupling element which allows coupling of a hose. The hose trolley may employ liquid such as water and find application in lawn or garden watering, water sprinkling, spraying or floor cleaning. The liquid connector may be removable coupled with the hose trolley and may be further connected with additional liquid units as per the requirement or application.

According to an embodiment of the present disclosure, the plurality of outlets are two outlets, where a flow of the liquid from the outlets is regulated by one or more of a regulating valve, and an aqua stop tap. Application of the valve and the tap may allow that the liquid flow from the plurality of outlets of the liquid connector is regulated or controlled for judicious use and reduced wastage.

According to an embodiment of the present disclosure, the outlet with the regulating valve is provided with a knob to control flow of the liquid therethrough, and the outlet with the aqua stop tap is provided with a self-closing tap connector. The liquid flow from the plurality of outlets of the liquid connector may be regulated or controlled using knobs or self-closing tap connectors.

According to an embodiment of the present disclosure, the corresponding structure is a tube or the handle of the hose trolley. The liquid connector may be removably coupled with the handle of the hose trolley, along different positions, arrangements as per the need.

Other features and aspects of this invention will be apparent from the following description and the accompanying drawings.

### BRIEF DESCRIPTION OF THE DRAWINGS

The invention will be described in more detail with reference to the enclosed drawings, wherein:

FIG. 1 shows a perspective view of a hose trolley with a liquid connector, in accordance with an aspect of the present disclosure;

FIG. 2 shows a perspective view of the liquid connector, in accordance with an aspect of the present disclosure;

FIG. 3 shows a perspective view of the hose trolley with the liquid connector connected with a regulating valve, in accordance with an aspect of the present disclosure; and

FIG. 4 shows another perspective view of the hose trolley with the liquid connector connected with a sprinkler, in accordance with an aspect of the present disclosure.

### DESCRIPTION OF EMBODIMENTS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention may be utilized in other embodiments and even other types of structures and/or methods. In the drawings, like numbers refer to like elements.

Certain terminology is used herein for convenience only and is not to be taken as a limitation on the invention. For example, “upper”, “lower”, “front”, “rear”, “side”, “longitudinal”, “lateral”, “transverse”, “upwards”, “downwards”, “forward”, “backward”, “sideward”, “left,” “right,” “horizontal,” “vertical,” “upward”, “inner”, “outer”, “inward”, “outward”, “top”, “bottom”, “higher”, “above”, “below”, “central”, “middle”, “intermediate”, “between”, “end”, “adjacent”, “proximate”, “near”, “distal”, “remote”, “radial”, “circumferential”, or the like, merely describe the configuration shown in the Figures. Indeed, the components may be oriented in any direction and the terminology, therefore, should be understood as encompassing such variations unless specified otherwise.

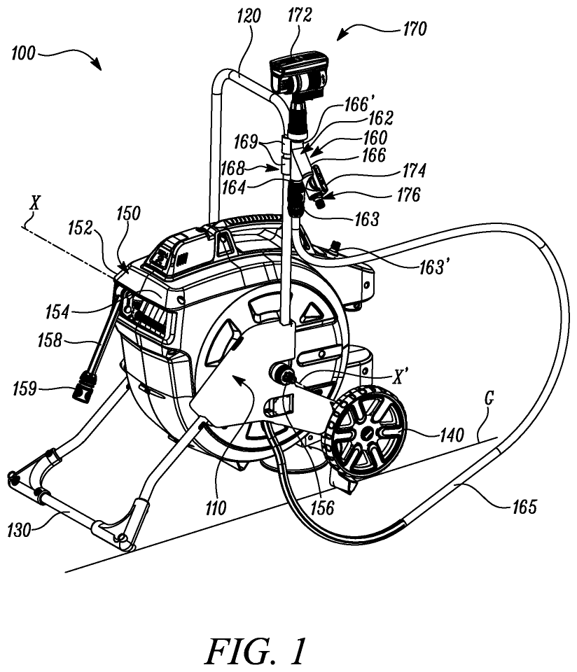

FIG. 1 illustrates a hose trolley 100. The hose trolley 100 is used to house, store and transport a hose box 150 to different installations, such as lawns, parks, and the like for providing a flow of liquid, such as water. The flow of liquid may be provided for firefighting, gardening, surface cleaning and the like activities. The hose trolley 100 includes a frame 110 that defines a central axis X-X′. The frame 110 may be rigid as well as light weight, depending upon application requirements, user-preference, or other considerations. The frame 110 may be manufactured using a metal (preferably aluminum), alloy and the like.

The frame 110 of the hose trolley 100 includes a handle 120, a support stand 130. The hose trolley 100 includes one or more wheels 140 adapted to transport the frame 110, and the hose box 150 housed with the frame 110 and a liquid connector 160. The handle 120 of the hose trolley 100 may be pivotably coupled to the frame 110, for desired ergonomics The pivotable handle 120 may also make the hose trolley 100 more compact for packaging, storage, and travel. In some embodiments, the handle 120 may include a locking mechanism (not shown) to lock the handle 120 in the pivotable position. The locking mechanism may provide a safe and trouble-free operation by disallowing any accidental movement of the pivotable handle 120. The locking mechanism may be lever such as a ring-shaped lever to allow easy locking/unlocking of the handle 120. In some embodiments, the handle 120 may be telescopic. The telescopic nature of the handle 120 may further improve the ergonomics of the hose trolley 100. The user may adjust the height of the handle 120 to a comfortable position and easily hold or maneuver the hose trolley 100 on the ground “G”.

The support stand 130 of the hose trolley 100 may have a U-shape grip. The support stand 130 may preferably be formed in one piece or alternatively may be formed in two pieces connected to each other by any means know in the art. The one or more wheels 140 of the hose trolley 100 may be rotatably coupled with an axle (not shown). The one or more wheels 140 may case support and movement of the hose trolley 100 on the ground “G” or improve portability between different locations/installations. In some embodiments, the one or more wheels 140 may be caster wheels. The caster wheels 140 may help to easily manipulate the hose trolley 100 on the ground “G”. In some embodiments, the one or more wheels 140 and the axle may be provided with dampers (not shown) to avoid shocks incurred due to movement on any uneven surfaces, among other considerations. In some embodiments, the one or more wheels 140 may be powered by an electric motor (not shown), or any other powering means. In some embodiments, the one or more wheels 140 may be removably coupled with the frame 110. The one or more wheels 140 may be removable to allow easy servicing, or even replacement. Further, the removable feature of the one or more wheels 140 may make the hose trolley 100 more compact for packaging.

The hose box 150 housed with the frame 110 of the hose trolley 100 may have a circular, a rectangular or any other shape without limiting the scope of the disclosure. The hose box 150 may be made from metal, fiberglass, or plastic. The hose box 150 may include a first part 152 and a second part 154. The first part 152 and the second part 154 may be temporarily or permanently attached to each other, such as by fasteners, screws, any suitable means as used or known in the art. The hose box 150 may be connected to an external liquid source via a hose (not shown). The hose may be connected to the frame 110 of the hose trolley 100 by a nipple 156. Further, the hose box 150 may house a hose reel (not shown) that may wind and unwind a hose 158. The free end of the hose 158 may be connected to a coupling element 159 to couple accessories such as, but not limited to, a shower head, spray gun and the like.

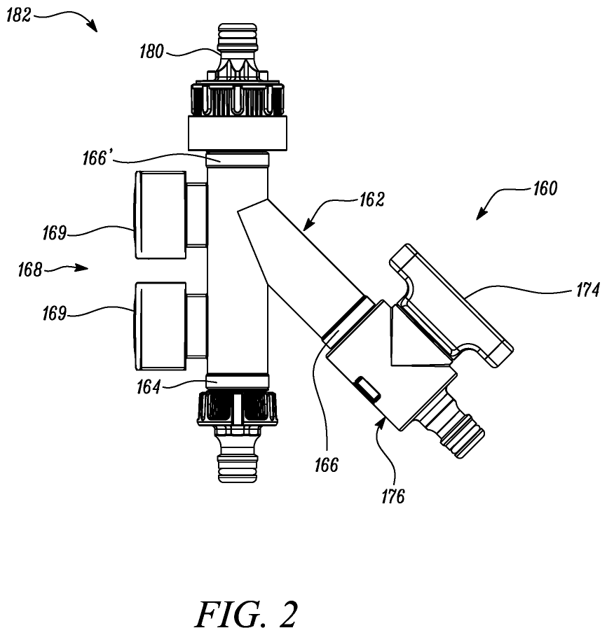

The liquid connector 160, as illustrated in FIG. 2, includes a body 162 defining an inlet 164 and a plurality of outlets 166, 166′. The body 162 allows flow of a liquid from the inlet 164 to one or more of the plurality of outlets 166, 166′. A fixing element 168 is adapted to allow coupling of the liquid connector 160 with the hose trolley 100. The fixing element 168 of the present disclosure is one or more coupling elements 169 provided on the body 162. The one or more coupling elements 169 allow removable coupling of the liquid connector 160 with a corresponding structure of the hose trolley 100. In some embodiments, the corresponding structure may be a tube or a handle 120 of the hose trolley 100 (as shown in FIG. 1). The liquid connector 160 may be removably coupled with the handle 120 of the hose trolley 100. The user may removably couple the liquid connector 160 along any position, length, angle of the handle 120 according to application requirements.

In some embodiments, the one or more coupling elements 169 allow removable coupling by one or more of a screw connection, fixtures, and clips.

Thus, the removable coupling may be accomplished using accessories that are robust, light in weight and may be worked upon by any person with limited application of different tools, technical knowledge, or skill. In some embodiments, the one or more coupling elements 169 may be separately and fixedly provided with the handle 120 of the hose trolley 100. The liquid connector 160 may then be engaged with the one or more coupling elements 169.

In some embodiments, the inlet 164 of the body 162 of the liquid connector 160 includes a coupling element 163 which allows coupling of a hose 165. The hose 165 is coupled to the inlet 164 of the body 162 of the liquid connector 160 for connection with the liquid source. The present disclosure exemplary refers to water, interchangeably as the liquid, without any limitation, as the water finds vast application in irrigation of plants, lawns, gardens, and the like.

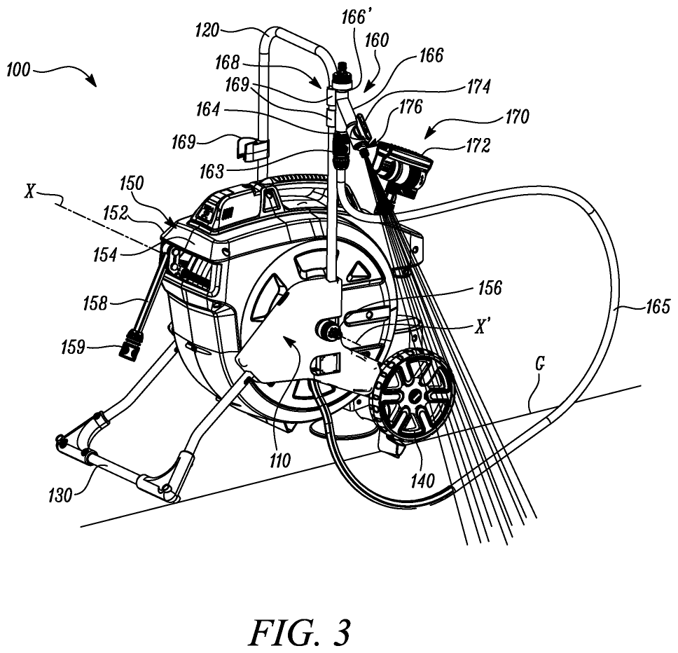

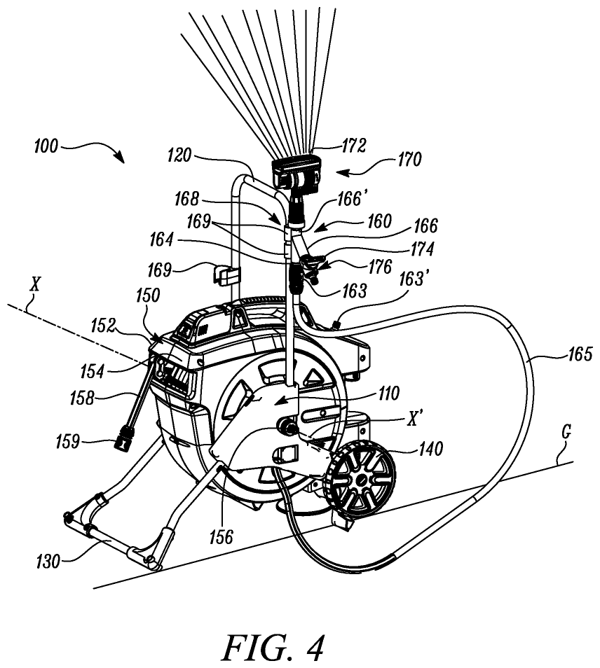

As illustrated in FIGS. 3 and 4, the plurality of outlets 166, 166′ of the water connector 160 are two outlets 166, 166′. The plurality of outlets 166, 166′ of the water connector 160 may increase the utility of the water connector 160 and hence the hose trolley 100. The outlets 166, 166′ allow application of additional watering units 170, hoses and the like, that may be rotatably and removably connected to the water connector 160 as shown in FIG. 4. The additional watering units 170 may be one or more of a sprinkler 172, water tap (not shown) or the like.

In some embodiments, the frame 110 of the hose trolley 100 includes an additional coupling element 163′ which allows coupling of a hose (not shown) or the additional watering unit 170 for non-use case thereof, as shown in FIG. 3.

In some embodiments, the plurality of outlets 166, 166′ may be provided with different valves, switches and the like to regulate or control flow of the water. The water flow may be regulated by one or more of a regulating valve 176 as shown in FIG. 3, and an aqua stop tap 182. The outlet 166 with the regulating valve 176 is provided with a knob 174 to control flow of the water therethrough. The user may easily move or rotate the knob 174 as per the requirement to control water Further, the outlet 166′ with the aqua stop tap 182 is provided with a self-closing tap connector 180. Thus, the water outflow from the outlet 166′ is automatically ceased as soon as the additional watering unit 170 is disengaged.

Thus, the present disclosure provides the water connector 160 that may increase the overall utility of the hose trolley 100. The water connector 160 may connect different additional watering unit 170. The water tap may be adapted for a wide range of applications such as hand cleaning, bucket filling etc. The water connector 160 may further connect a sprinkler 172. Furthermore, the removable coupling of the water connector 160 may allow for easy servicing and replacement of the water connector 160. The removable coupling may also give the user a freedom to couple the water connector 160 with the hose trolley 100 only when required.

In the drawings and specification, there have been disclosed preferred embodiments and examples of the invention and, although specific terms are employed, they are used in a generic and descriptive sense only and not for the purpose of limitation of the scope of the invention being set forth in the following claims.

### LIST OF ELEMENTS

100 Hose Trolley
110 Frame
120 Handle
130 Support Stand
140 Wheels
150 Hose Box
152 First Part
154 Second Part
156 Nipple
158 Hose
159 Coupling Element
160 Liquid/Water Connector
162 Body
163 Coupling Element
163′ Additional Coupling Element
164 Inlet
165 Hose
166 Outlet
166′ Outlet
168 Fixing Element
169 Coupling Element
170 Additional Watering Units
172 Sprinkler
174 Knob
176 Regulating Valve
180 Self-closing Tap Connector
182 Aqua Stop Tap
X-X′ Central Axis
G Ground

1. A liquid connector for a hose trolley, comprising:
a body defining an inlet and a plurality of outlets, wherein the body allows flow of a liquid from the inlet to one or more of the plurality of outlets; and
a fixing element adapted to allow coupling of the liquid connector with the hose trolley,
wherein the inlet of the body includes a coupling element which allows coupling of a hose;
wherein the fixing element is one or more coupling elements provided on the body, wherein the one or more coupling elements allow removable coupling of the liquid connector with a corresponding structure.

2. The liquid connector of claim 1, wherein the plurality of outlets are two outlets, wherein a flow of the liquid from the two outlets is regulated by one or more of a regulating valve, and an aqua stop tap.

3. The liquid connector of claim 1, wherein the outlet with the regulating valve is provided with a knob to control flow of the liquid therethrough, and the outlet with the aqua stop tap is provided with a self-closing tap connector.

4. The liquid connector of claim 1, wherein the corresponding structure is a tube or a handle of the hose trolley.

5. The liquid connector of claim 1, wherein the one or more coupling elements allow coupling by one or more of a screw connection, fixtures, and clips.

6. A hose trolley with the liquid connector of claim 1,
the hose trolley comprising:
a frame defining a central axis, wherein the frame includes:
a handle; and
one or more wheels adapted to transport the frame; and
a hose box housed with the frame.

7. The hose trolley of claim 6, wherein the corresponding structure is a tube or the handle of the hose trolley.
